(19) United States
(12) Patent Application Publication
(10) Pub. No.: US 2009/0114604 A1
(43) Pub. Date: May 7, 2009

(54) Method and System for Photocatalytically Decomposing Organic Pollutants Using Electromotive Force of Solar Cell

(75) Inventors: Shin Tae Bae, Seoul (KR); Kug Sun Hong, Seoul (KR); Sang Wook Lee, Seoul (KR); In Sun Cho, Namyangju-si (KR); Jun Hong Noh, Seoul (KR); Chin Moo Cho, Seoul (KR); Dong Wook Kim, Seongnam-si (KR); Tae Hoon Noh, Seoul (KR); Chae Hyun Kwak, Bucheon-si (KR)

Correspondence Address: THE WEBB LAW FIRM, P.C., 700 KOPPERS BUILDING, 436 SEVENTH AVENUE, PITTSBURGH, PA, 15219, US

(73) Assignee: SEOUL NATIONAL UNIVERSITY INDUSTRY FOUNDATION, Seoul (KR)

(21) Appl. No.: 11/970,218

(22) Filed: Jan. 7, 2008

(30) Foreign Application Priority Data
Nov. 7, 2007 (KR) 10-2007-0113029

(51) Int. Cl. B01J 19/08; C02F 1/48; C02F 1/72

(52) U.S. Cl. 210/748; 422/186.21; 210/758

(57) ABSTRACT

The present invention relates to a method and system for photocatalytically decomposing organic pollutants using the electromotive force of a solar cell. The present invention provides a method and system for decomposing organic pollutants, which can greatly increase the rate of decomposition of organic pollutants at low cost by combining a photocatalytic organic pollutant decomposition device, capable of decomposing organic pollutants using light energy, with a solar cell, capable of applying an external voltage to the photocatalytic organic pollutant decomposition device using light energy.

### TECHNICAL FIELD

The present invention relates to a method and system for photocatalytically decomposing organic pollutants using the electromotive force of a solar cell, and, more particularly, to a method and system for decomposing organic pollutants, which can greatly increase the rate of decomposition of organic pollutants at low cost by combining a photocatalytic organic pollutant decomposition device, capable of decomposing organic pollutants using light energy, with a solar cell capable of applying external voltage to the photocatalytic organic pollutant decomposition device using light energy.

### BACKGROUND ART

With the advancement of various industries, environmental pollution problems are becoming serious, and thus pollutant emission standards are becoming stricter.

Therefore, various methods and apparatuses for decomposing or purifying pollutants have been considered. However, as the number of kinds of pollutant sources increases, that is, as new pollutants are generated, more and more methods of solving the environmental pollution problem are proposed.

Current examples of commonly-used methods of removing pollutants from water include a method of removing pollutants by adsorbing them using activated carbon and methods of removing pollutants through aggregation, chemical oxidation treatment, such as Fenton oxidation etc., biological treatment using microbes, and the like.

However, the above methods have fundamental problems. Among them, the method of removing pollutants by adsorbing them using activated carbon is problematic in that pollutants are not completely decomposed, and a secondary treatment process for removing the pollutants adsorbed on the activated carbon is required.

The chemical oxidation treatment is also problematic in that organic substances are not completely decomposed, and a large amount of precipitated sludge is formed, thus causing secondary pollution.

Further, the biological treatment is also problematic in that pollutants are very slowly decomposed, and it is difficult to maintain treatment conditions such that the entire reaction system exhibits biological activity.

A recently devised method of treating organic pollutants using a photocatalytic reaction, which is attracting considerable attention as a novel pollutant treatment technology, is a process of directly decomposing and treating pollutants in water, and is influenced relatively little by temperature, pH, pollutant concentration, and the like, and thus the treatment conditions are not greatly limited. In particular, the method is very advantageous in that harmful organic substances can be removed without generating secondary pollutants.

In the method of treating organic pollutants using a photocatalytic reaction, the photocatalytic reaction using TiO₂, serving as a photocatalyst, and light energy will be described. First, when TiO₂, serving as a photocatalyst, is irradiated with light energy greater than the band gap energy of TiO₂between the valence band and conduction band, holes and electrons are formed in the valence band and the conduction band of TiO₂, respectively. In this case, the holes formed in the valence band move to the surface of a photocatalyst, and react with water molecules, thus forming OH radicals. The organic pollutants adsorbed on the surface of the photocatalyst particles are oxidized and then decomposed by the oxidizability of the formed OH radicals. Further, the electrons formed in the conduction band electrochemically adsorb heavy metal ions and oxygen, and then reduce the heavy metal ions or form superoxide radicals. The formed superoxide radicals directly decompose organic pollutants, or form OH radicals and cause the OH radicals to decompose organic pollutants.

As described above, the method of decomposing organic pollutants using a photocatalyst is an environment-friendly pollutant removal method, and has great possibilities. The present invention provides a system and method for decomposing organic pollutants using such a photocatalyst.

### DISCLOSURE

### [Technical Problem]

For this reason, in order to overcome the above problems occurring in the prior art, the present inventors have used a method of combining a photocatalytic organic pollutant decomposition device capable of decomposing organic pollutants using light energy with a solar cell capable of applying voltage to the photocatalytic organic pollutant decomposition device using light energy. As a result, they found that the method can greatly increase the rate of decomposition of organic pollutants. Based on the finding, the present invention was completed.

Accordingly, an object of the present invention is to provide a method and system for decomposing a larger amount of organic pollutants at low cost using the method of combining a photocatalytic organic pollutant decomposition device with a solar cell.

### [Technical Solution]

In order to accomplish the above object, the present invention provides a method of decomposing organic pollutants using a photocatalytic reaction, including: combining a photocatalytic organic pollutant decomposition device, which uses light energy, with a solar cell capable of producing a voltage; and applying the voltage, produced from the solar cell using light energy, to the photocatalytic organic pollutant decomposition device to decompose the organic pollutants.

Here, the photocatalytic organic pollutant decomposition device includes a first working electrode and a first counter electrode, which are used to form electrons and holes from a photocatalytic material, and the first working electrode and the first counter electrode contact an electrolyte and the organic pollutants to conduct the photocatalytic reaction between the first working electrode and the first counter electrode using the light energy.

Moreover, the method of decomposing organic pollutants may further include the step of injecting oxygen into the electrolyte to react the oxygen with electrons.

Further, the present invention provides a system for decomposing organic pollutants using a photocatalytic reaction, including a photocatalytic organic pollutant decomposition device which decomposes the organic pollutants through a photocatalytic reaction using light energy; and a solar cell which produces a voltage using light energy and then applies the voltage to the photocatalytic organic pollutant decomposition device.

Here, the photocatalytic organic pollutant decomposition device includes a first working electrode and a first counter electrode, which are used to form electrons and holes from a photocatalytic material; and a first electrolyte, which contacts the first working electrode and the first counter electrode and reacts with the produced electrons and holes to oxidize and decompose the organic pollutants. The solar cell may be supplied with external light energy and then convert the light energy into electric energy to apply a voltage between the first working electrode and the first counter electrode. Further, the solar cell may include a second counter electrode connected to the first working electrode, and a second working electrode connected to the first counter electrode.

Moreover, the first working electrode may include a photocatalytic material for forming electrons and holes using light energy.

Preferably, solar cells are connected to each other in series, and the solar cells apply a voltage to the photocatalytic organic pollutant decomposition device.

This solar cell may be at leas one selected from among a dye-sensitive solar cell, a silicon solar cell, a semiconductor solar cell, and a multi-layered solar cell.

Furthermore, the system for decomposing organic pollutants may include an oxygen injection unit for injecting oxygen into the first electrolyte of the photoelectrochemical cell.

### ADVANTEGEOUS EFFECTS

According to the system and method for decomposing organic pollutants using the electromotive force of a solar cell by combining a photocatalytic organic pollutant decomposition device with a solar cell of the present invention, the photocatalytic organic pollutant decomposition device obtains a larger electric potential difference because it is supplied with voltage from the solar cell using light energy, thereby greatly increasing the rate of decomposition of organic pollutants at low cost.

Further, according to the present invention, organic pollutants are decomposed using a photocatalytic reaction, so that secondary pollutants are not formed, thereby providing an environment-friendly pollutant decomposition method and system.

### DESCRIPTION OF DRAWINGS

FIG. 1 is a schematic view showing a photocatalytic organic pollutant decomposition system according to the present invention;

FIG. 2 is a schematic view showing the operation of the photocatalytic organic pollutant decomposition system using the electromotive force of a solar cell according to the present invention;

FIG. 3 is a graph showing the relationship between photocurrent density and organic matter decomposition rate in a photocatalytic organic pollutant decomposition device depending on externally applied voltage; and

FIG. 4 is a graph showing the organic matter decomposition rate in the photocatalytic organic pollutant decomposition device depending on whether or not a solar cell operates, the organic matter decomposition rate thereof being measured using the methods of Examples 1 and 2 and Comparative Example.

### DESCRIPTION OF THE ELEMENTS IN THE DRAWINGS

100 photocatalytic organic pollutant decomposition device

110 first working electrode

120 first counter electrode

130 photocatalytic material

150 first electrolyte and pollutant

200 solar cell

210 second working electrode

220 second counter electrode

250 second electrolyte

### [Best Mode]

Hereinafter, preferred embodiments of the present invention will be described in detail with reference to the attached drawings.

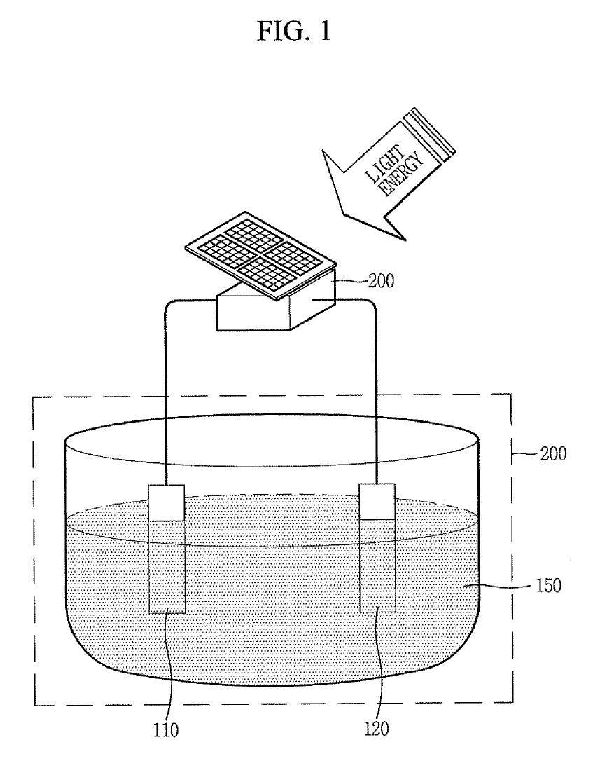

The present invention provides a system for decomposing organic pollutants using a photocatalytic reaction, including a photocatalytic organic pollutant decomposition device which decomposes the organic pollutants through the photocatalytic reaction using light energy, and a solar cell which produces a voltage using light energy and then applies the voltage to the photocatalytic organic pollutant decomposition device. FIG. 1 is a schematic view showing a photocatalytic organic pollutant decomposition system using the electromotive force of a solar cell as an external voltage according to the present invention.

As shown in FIG. 1, the system for decomposing organic pollutants according to the present invention include a photoelectrochemical cell 100, which is the photocatalytic organic pollutant decomposition device, and a solar cell 200.

Here, the solar cell 200 in FIG. 1 is shown as a solar cell that uses solar radiation collection plates, but is shown in order to depict the characteristics of a typical solar cell, and is not limited thereto. Examples of the solar cell 200 may include dye-sensitive solar cells, silicon solar cells, semiconductor solar cells, multi-layered solar cells, and the like.

The photocatalytic organic pollutant decomposition device 100 is configured such that a first working electrode 110 for using a photocatalytic reaction and a first counter electrode 120 contact a first electrolyte and organic pollutants 150.

The solar cell 200 serves to increase the voltage that is applied to the photocatalytic organic pollutant decomposition device 100 using external light energy in order to increase the organic pollutant decomposition rate of the photocatalytic organic pollutant decomposition device 100.

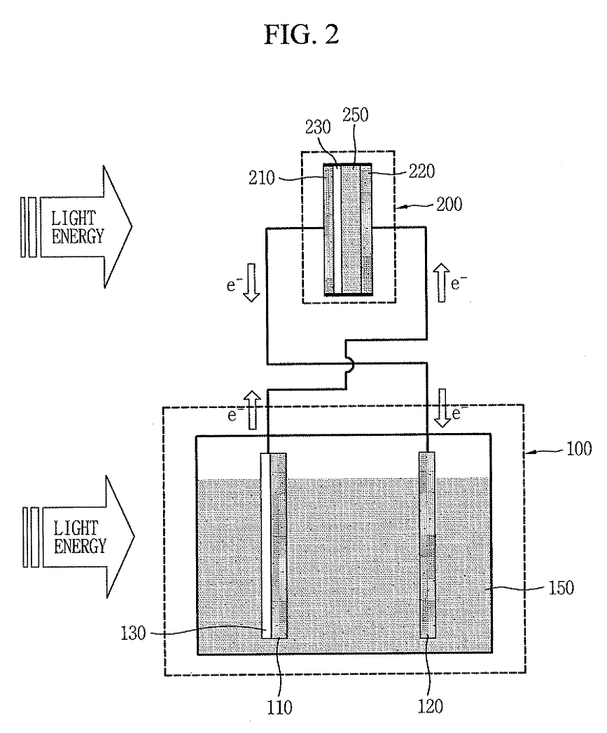

FIG. 2 is a schematic view showing the operation of the photocatalytic organic pollutant decomposition system according to the present invention.

FIG. 2 shows an example in which a photoelectrochemical cell is used as the photocatalytic organic pollutant decomposition device 100, and a dye-sensitive solar cell is used as the solar cell 200. However, this example is only set forth for illustrative purposes, and other kinds of solar cells may be used.

The photoelectrochemical cell 100, which is the photocatalytic organic pollutant decomposition device of the present invention, includes a first working electrode 110, a first counter electrode 120 and a first electrolyte 150. The first working electrode 110 includes a photocatalytic material 130, which forms holes and electrons using light energy, and a transparent pole into which electrons are injected and diffused. As the photocatalytic material 130, titanium dioxide (TiO₂) is used, but the present invention is not limited thereto. As the transparent pole, indium tin oxide (ITO) is used, but the present invention is not limited thereto.

Further, as the counter electrode 120, metals which are stable in the first electrolyte 150, preferably platinum, gold, and silver, may be used. As the first electrolyte 150, a 0.1 M sodium chloride aqueous solution is used, but the present invention is not limited thereto.

The mechanism of decomposing organic pollutants through the system for photocatalytically decomposing organic pollutants according to the present invention is as follows. First, when external light energy is applied to the photocatalytic organic pollutant decomposition device 100, holes and electrons are formed in the first working electrode. The formed holes react with water to form hydroxyl (OH) radicals, and thus organic pollutants are oxidized and then decomposed by the oxidizability of the formed hydroxyl (OH) radicals. Furthermore, when the photocatalytic organic pollutant decomposition device 100 further includes an oxygen injection device, so as to inject oxygen into the first electrolyte 150, electrons react with oxygen to form super oxygen, thus increasing the rate of decomposition of organic pollutants using the oxidizability of the formed super oxygen.

However, when only the photoelectrochemical cell 100, serving as the photocatalytic organic pollutant decomposition device 100, is used, since the voltage difference between the first working electrode 110 and the first counter electrode 120 is not large, the rate of decomposition of organic pollutants is limited. For this reason, in the present invention, the photoelectrochemical cell 100, serving as the photocatalytic organic pollutant decomposition device 100, is combined with a solar cell 200 capable of applying an external voltage to the photoelectrochemical cell 100, so that the voltage difference between the first working electrode 110 and the first counter electrode 120 is increased, thereby decomposing a larger amount of organic pollutants.

In this case, the solar cell 200 that is used in the present invention may be appropriately selected from among a dye-sensitive solar cell, a silicon solar cell, a semiconductor solar cell, and a multi-layered solar cell, but is not limited thereto.

Among the exemplified solar cells, the dye-sensitive solar cell includes a second working electrode 210 coated with titanium dioxide (TiO₂) 230 having a dye adsorbed thereon for forming electrons and holes, a second counter electrode 220 composed of platinum, which is a precious metal, and a second electrolyte 250 containing an iodine oxidation-reduction pair. In contrast, other kinds of solar cells may have a different configuration. As the first working electrode 110, first counter electrode 120 and first electrolyte 150 of the photoelectrochemical cell 100, which serves as the photocatalytic organic pollutant decomposition device, other kinds of working electrodes, counter electrodes and electrolytes may be used.

In the present invention, the second working electrode 210 of the solar cell 200 is connected to the first counter electrode 120 of the photoelectrochemical cell 100, and the second counter electrode 220 of the solar cell 200 is connected to the first working electrode 110 of the photoelectrochemical cell 100, thus forming a system for decomposing organic pollutants using the electromotive force of a solar cell.

Further, in the present invention, one solar cell may be used, and several solar cells may be used in a state in which they are connected to each other in series. When several solar cells are connected to each other in series, the voltage difference across them is increased, and thus the rate of decomposition of organic pollutants can be increased.

Hereinafter, the effect of the external voltage on the operation of the photocatalytic organic pollutant decomposition device using the electromotive force of a solar cell according to the present invention will be described.

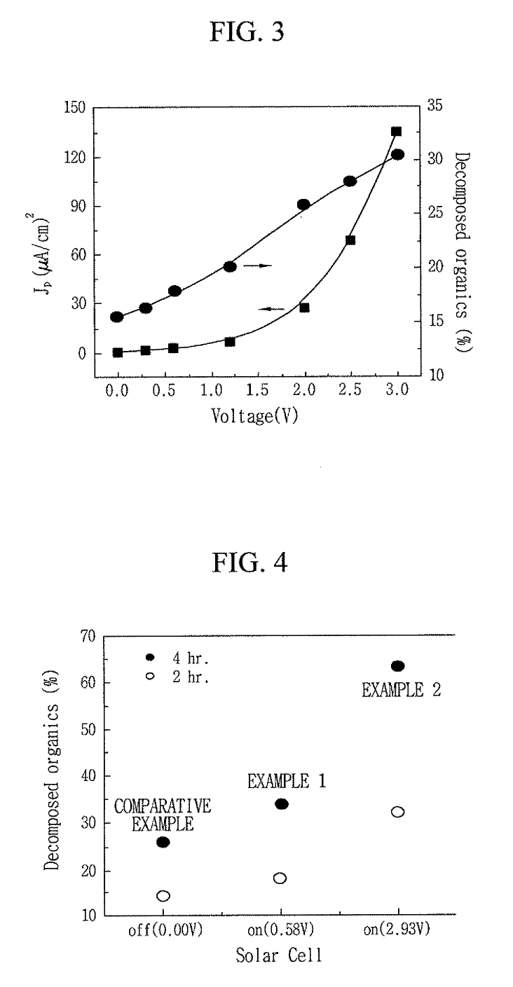

As shown in FIG. 3, it can be seen that both the photocurrent density and the organic pollutant decomposition rate are increased depending on the increase in external voltage. Further, it can be seen that the composition rate (31.08%, 2 hours) of organic matter when 3.0 V of external voltage is applied is two times of the decomposition rate (14.47%, 2 hours) of organic matter (phenol 10 ppm) when 0.0 V of external voltage is applied. The reason is that electrons formed by light are accelerated by an electric field, and thus drift along the electric field.

As described above, when the voltage of a solar cell is used as external voltage, both the photoelectrochemical cell 100 and the solar cell 200 use only light energy, which does not cause environmental pollution, thus providing a system and method for decomposing organic pollutants, which can increase the rate of decomposition of organic pollutants at low cost.

### [Mode for Invention]

Hereinafter, the present invention will be described in more detail with reference to the following Examples, which are set forth to illustrate, but are not to be construed as the limit of the present invention. In the following Examples, a halogen lamp was used as a light source of a solar cell due to its instability in energy emission when account was taken of the fact that the light energy from the sun is practically not constant, and a photocatalytic organic decomposition device was tested using an ultraviolet lamp which can sufficiently activate titanium dioxide, which is a photocatalyst of a working electrode. Further, phenol, which serves as a poorly degradable organic, was dissolved in an amount of 10 ppm in an electrolyte solution and monitored for decomposition rate.

### EXAMPLE 1

A dye-sensitive solar cell, which generates a voltage of 0.58 V in the presence of 100 mW/cm² of halogen light generated from a halogen lamp, and which includes a working electrode fabricated by coating an indium-tin oxide (ITO) transparent pole with titanium dioxide and then supporting the transparent pole with a ruthenium dye, a platinum counter electrode, and an electrolyte composed of tetraethylene glycol dimethyl ether and iodine, was fabricated. Further, a photoelectrochemical cell, which decomposes organic matter using ultraviolet light generated from a 10 W ultraviolet lamp, and which includes a working electrode fabricated by coating an indium-tin oxide (ITO) transparent pole with titanium dioxide, a platinum counter electrode, and an electrolyte composed of 0.1 M sodium chloride, was fabricated.

Subsequently, the working electrode and counter electrode of the dye-sensitive solar cell are connected to the counter electrode and the working electrode of the photoelectrochemical cell, respectively, thus forming a system for decomposing organic pollutants using a photocatalyst.

The photocurrent density of the photocatalytic organic pollutant decomposition device was measured using a precise current measuring device, and as a result, the photocurrent density thereof was found to be 2.98 μA/cm². Further, the rate of decomposition of organic pollutants of the photocatalytic organic pollutant decomposition device was measured using a UV-Vis spectrophotometer for 2 hours, and as a result, the rate of decomposition of phenol was found to be 17.94%.

Meanwhile, FIG. 4 is a graph showing the organic matter decomposition rate of the photocatalytic organic pollutant decomposition device depending on whether or not the solar cell operates. As shown in FIG. 4, it can be seen that, in the system for decomposing organic pollutants using the electromotive force of a solar cell, the electromotive force of the solar cell, like the external voltage, increases the voltage difference between the working electrode and the counter electrode of the photocatalytic organic pollutant decomposition device, thus increasing the rate of decomposition of organic pollutants.

### EXAMPLE 2

Example 2 was conducted as Example 1, except that two dye-sensitive solar cells, which were connected to each other, and which generate a voltage of 2.93 V in the presence of 100 mW/cm² of halogen light generated from a halogen lamp, were used.

The photocurrent density of the photocatalytic organic pollutant decomposition device was measured using a precise current measuring device, and as a result, the photocurrent density thereof was found to be 30.08 μA/cm². Further, the rate of decomposition of organic pollutants of the photocatalytic organic pollutant decomposition device was measured using a UV-Vis spectrophotometer for 2 hours, and as a result, the rate of decomposition of phenol was found to be 31.98%, as shown in FIG. 4.

### COMPARATIVE EXAMPLE

A system for decomposing organic pollutants using ultraviolet light generated from a 10 W ultraviolet lamp, in which a photocatalytic organic pollutant decomposition device is not connected to a solar cell, was used. The photocurrent density of the photocatalytic organic pollutant decomposition device was measured using an precise current measuring device, and as a result, the photocurrent density thereof was found to be 0.54 μA/cm². Further, the rate of decomposition of organic pollutants of the photocatalytic organic pollutant decomposition device was measured using a UV-Vis spectrophotometer for 2 hours, and as a result, the rate of decomposition of phenol was found to be 14.47%, as shown in FIG. 4.

The results of Example 1, Example 2 and Comparative Example are given in Table 1.

TABLE 1

| | | | Photocurrent density of | Rate of |
|---|---|---|---|---|
| | | | organic pollutant | decomposition |
| | Solar cell | Solar cell | decomposition device | of phenol (%, |
| Class. | voltage (V) | current (mA) | (μA/cm²) | 2 hours) |
| Example 1 | 0.58 | 3.75 | 2.98 | 17.94 |
| Example 2 | 2.93 | 3.69 | 30.08 | 31.98 |
| Comparative | — | — | 0.54 | 14.47 |
| Example | | | | |

From Table 1, it can be seen that the rate of decomposition of organic pollutants in the system for decomposing organic pollutants in which the photocatalytic organic pollutant decomposition device is connected to the solar cell according to the present invention was increased compared to the conventional system for decomposing organic pollutants without using light energy in Comparative Example. Furthermore, it can be seen that, when solar cells are connected to each other in series and thus the voltage difference is increased, the rate of decomposition of organic pollutants is increased.

In the description of the present invention, the organic pollutant decomposition device is a device that includes the photoelectrochemical cell. In the case where the description of the operation of the photoelectrochemical cell is required, the organic pollutant decomposition device was clearly expressed by the photoelectrochemical cell.

As described above, although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the above Examples are set forth to illustrate the technical idea of the present invention, rather than to limit the technical idea thereof, but are not to be construed as the limit of the present invention. The scope of protection of the present invention must be construed by claims, and it is to be construed that the entire technical ideas equivalent to claims are included in the scope of right of the present invention.

1. A method of decomposing an organic pollutant using a photocatalytic reaction, comprising:
combining a photocatalytic organic pollutant decomposition device, which uses light energy, with a solar cell capable of producing a voltage; and
applying the voltage, produced from the solar cell using light energy, to the photocatalytic organic pollutant decomposition device to decompose the organic pollutant.

2. The method of decomposing an organic pollutant according to claim 1,
wherein the photocatalytic organic pollutant decomposition device comprises a first working electrode and a first counter electrode, which are used to form electrons and holes from a photocatalytic material, and
the first working electrode and the first counter electrode contact an electrolyte and the organic pollutant to conduct the photocatalytic reaction between the first working electrode and the first counter electrode using the light energy.

3. The method of decomposing an organic pollutant according to claim 1, further comprising:
injecting oxygen into the electrolyte to react the oxygen with electrons.

4. A system for decomposing an organic pollutant using a photocatalytic reaction, comprising:
a photocatalytic organic pollutant decomposition device which decomposes the organic pollutant through the photocatalytic reaction using light energy; and
a solar cell which produces a voltage using light energy and then applies the voltage to the photocatalytic organic pollutant decomposition device.

5. The system for decomposing an organic pollutant according to claim 4,
wherein the photocatalytic organic pollutant decomposition device comprises a first working electrode and a first counter electrode, which are used to form electrons and holes from a photocatalytic material; and a first electrolyte which contacts the first working electrode and the first counter electrode and reacts with the produced electrons and holes to oxidize and decompose the organic pollutant, and
wherein the solar cell is supplied with external light energy and then converts the light energy into electric energy to apply a voltage between the first working electrode and the first counter electrode.

6. The system for decomposing an organic pollutant according to claim 5, wherein the solar cell comprises a second counter electrode connected to the first working electrode, and a second working electrode connected to the first counter electrode.

7. The system for decomposing an organic pollutant according to claim 5, wherein the first working electrode includes a photocatalytic material for forming electrons and holes using light energy.

8. The system for decomposing an organic pollutant according to claim 4, wherein solar cells are connected to each other in series, and the solar cells apply a voltage to the photocatalytic organic pollutant decomposition device.

9. The system for decomposing an organic pollutant according to claim 8, wherein the solar cell is at least one selected from among a dye-sensitive solar cell, a silicon solar cell, a semiconductor solar cell, and a multi-layered solar cell.

10. The system for decomposing an organic pollutant according to claim 4, further comprising:
an oxygen injection unit for injecting oxygen into the first electrolyte of the photoelectrochemical cell.

11. The method of decomposing an organic pollutant according to claim 2, further comprising:
injecting oxygen into the electrolyte to react the oxygen with electrons.

12. The system for decomposing an organic pollutant according to claim 5, wherein solar cells are connected to each other in series, and the solar cells apply a voltage to the photocatalytic organic pollutant decomposition device.

13. The system for decomposing an organic pollutant according to claim 6, wherein solar cells are connected to each other in series, and the solar cells apply a voltage to the photocatalytic organic pollutant decomposition device.

14. The system for decomposing an organic pollutant according to claim 7, wherein solar cells are connected to each other in series, and the solar cells apply a voltage to the photocatalytic organic pollutant decomposition device.

15. The system for decomposing an organic pollutant according to claim 5, further comprising:
an oxygen injection unit for injecting oxygen into the first electrolyte of the photoelectrochemical cell.

16. The system for decomposing an organic pollutant according to claim 6, further comprising:
an oxygen injection unit for injecting oxygen into the first electrolyte of the photoelectrochemical cell.

17. The system for decomposing an organic pollutant according to claim 7, further comprising:
an oxygen injection unit for injecting oxygen into the first electrolyte of the photoelectrochemical cell.
